(19) United States
(12) Patent Application Publication
(10) Pub. No.: US 2007/0121742 A1
(43) Pub. Date: May 31, 2007

(54) Method and apparatus for encoded signal mapping for multi-carrier communication

(76) Inventors: Satoshi Tamaki, Kokubunji (JP); Takashi Yano, Tokorozawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/366,599

(22) Filed: Mar. 3, 2006

(30) Foreign Application Priority Data
Nov. 11, 2005 (JP) 2005-326852

(51) Int. Cl. H04K 1/10

(52) U.S. Cl. 375/260

(57) ABSTRACT

A communication quality is improved or signal processing is simplified in a multi-carrier communication system such as OFDM. Information different in communication quality such as systematic bits and parity bits of turbo encoded code words is combined together, and information that requires a high communication quality such as the systematic bits is mapped to carriers having a frequency close to the carriers in which the pilot signal exists used as a reference phase of demodulation than the information such as the parity bits which does not require the high communication quality such as the systematic bits.

### CLAIM OF PRIORITY

The present application claims from Japanese Application No. JP 2005-326852 filed on Nov. 11, 2005, the content of which is hereby incorporated by reference into this application.

### FIELD OF THE INVENTION

The present invention relates to a method for mapping an encoded signal in a multi-carrier communication that occurs a quality difference in each of carriers.

### BACKGROUND OF THE INVENTION

With wider bandwidths of a radio communication, there is used a multi-carrier communication system that divides transmit information into plural frequency bands which are called “sub-carrier” hereinafter to conduct communication. In the multi-carrier communication systems, an OFDM (orthogonal frequency division multiplexing) system uses plural frequencies that are orthogonal to each other within a symbol time range to require no guard bands between the respective sub-carriers and improve the frequency usability. As a result, the OFDM system is applied to various systems including a wireless LAN such as IEEE802.11a.

On the other hand, in the radio communication system, a turbo code is applied in Standards such as W-CDMA or cdma2000 as a channel code that is capable of obtaining an excellent error rate characteristic. FIG. 2 shows a flow of encoding the turbo code used in the Standard cdma2000 as an example of encoding the turbo code. In the figure, symbols of a cross shape inside of a circle are indicative of exclusive OR operation.

In the turbo encoding process shown in FIG. 2, information bits 200 that have been inputted to the encoding process are inputted to a switching module 216 and a turbo interleaver 205. The information bits that passed through the switching module 216 are directly outputted from the encoding process as systematic bits X210. The information bits that have passed through the switching module 216 are also inputted to a convolutional encoder 215, and convolutional operation results that have been subjected to shift registration and exclusive OR operation in the convolutional encoder 215 are outputted from the encoding process as parity bits Y₀211 and Y₁212. On the other hand, in the turbo interleaver 205, the information bits 200 are stored once, and then outputted to the switching module 226 after the bit order is changed by the interleaving process. The bits that have passed through the switching module 226 are directly outputted from the encoding process as the systematic bits X′220, or the convolutional operation results due to the shift register and the exclusive OR operation in the convolutional encoder 225 are outputted from the encoding process as parity bits Y′₀221 and Y′₁222. The switching modules 216 and 226 normally select the upper information bit side, and select and output the feedback group of a lower shift register when the encoding process has been completed.

In the turbo encoding process shown in FIG. 2, the systematic bits X210, X′220, and the parity bits Y₀211, Y₁212, Y′₀221, Y′₁222 are outputted in response to the input of the information bits 200. As a result, a code length generated is about 6 times of original information bits, that is, a code which is ⅙ in encoding rate is generated. When the code having the encoding rate which is higher than ⅙ is required, a part of the code that has been generated as an output of the turbo encoding process shown in FIG. 2 is punctured, or only necessary group is selected from the bits 210, 211, 212, 220, 221, and 222, to thereby generate the codes higher in the encoding rate.

Because the turbo codes thus generated are different in generating process between the systematic bits and the parity bits, the characteristics resulting from decoding the signal affected by noises or interferences at a receive side are different between the systematic bits and the parity bits. More specifically, the systematic bits are liable to be affected by the noises or interferences more than the parity bits, and the characteristics in the case where the noises or interferences affect the systematic bits are deteriorated greater than those in the case where the noises or interferences of the same power affect the systematic bits.

For that reason, for example, in “Multi-carrier transmitter and multi-carrier transmitting method” of JP-A No. 187257/2004, there has been introduced a technology in which the systematic bits are mapped to the sub-carriers in the vicinity of a center frequency, and the parity bits are mapped to the sub-carriers at both sides of the center frequency from the viewpoints that the sub-carriers at both sides of the center frequency face more interference from the adjacent channels than the sub-carries in the vicinity of the center frequency, and the characteristics are liable to be deteriorated.

Also, for example, in “Transmitting device and method, communication system, recording medium, and program” of JP-A 101504/2003, there has been introduced a technology in which a receiver side measures fading that occurs in a channel, and a transmitter side assigns the parity bits to the sub-carriers that are deteriorated by fading by using that information, to thereby reduce the deterioration.

### SUMMARY OF THE INVENTION

In the system that applies OFDM as with IEEE802.11a, a pilot signal with a reference amplitude and a reference phase is transmitted in a part of the sub-carriers, and a receiver station estimates a variation of the signal in the channel on the basis of the signal amplitude and phase of the measured pilot signal.

In signals other than the pilot signal, the sub-carriers in which no pilot signal exist is also subjected to interpolation, and the variation is estimated on the basis of the variation of the signal in the channel of the sub-carries in which the pilot signal which is estimated by using the pilot signal exists. Then, the estimated variation is compensated, and demodulation is conducted.

For that reason, when interpolation is conducted by a simple system, the sub-carriers farther not around (neighboring/adjacent to) the sub-carriers in which the pilot signal exists estimate the channel variation with an error with respect to a natural channel variation, and demodulation is conducted. As a result, the signals of the sub-carriers farther not around (neighboring/adjacent to) the pilot signal are more deteriorated. In the case where the signal whose deterioration is increased requires a high communication quality, for example, as with the systematic bits of the turbo code, and the information is low in error resistance, there arises such a problem that the characteristics of the entire communication are largely deteriorated.

The present invention has been made to solve the above problems, and therefore an object of the present invention is to provide a method for mapping a signal and a communication apparatus to which the method is applied, which do not largely deteriorate the characteristics even in the case of estimating a channel variation of another signal with the use of a simple interpolation system on the basis of a measurement result of a pilot signal through a multi-carrier communication system such as OFDM, and demodulating the signal.

In order to achieve the above object, according to the present invention, there is provided a method of mapping a signal in a multi-carrier radio communication system that divides information into plural carriers for communication, in which information different in required communication quality such as systematic bits and parity bits of turbo encoded code words are combined with each other, and information that requires the higher communication quality as with the systematic bits is mapped to carriers having a frequency closer to that of carriers in which a pilot signal used as a reference signal for obtaining a phase used for demodulation exists than information as with the parity bits which do not require the higher communication quality as with the systematic bits.

According to the present invention, there are provided a method for mapping a signal and a communication apparatus to which the method is applied, which do not largely deteriorate the characteristics even in the case of estimating a channel variation of another signal with the use of the simple interpolation system on the basis of the measurement result of the pilot signal through the multi-carrier communication system such as OFDM, and demodulating the signal.

The information different in required communication quality such as systematic bits and parity bits of turbo encoded code words are combined with each other, and information that requires the higher communication quality as with the systematic bits is mapped to carriers having a frequency closer to that of carriers in which a pilot signal used as a reference signal for obtaining a phase used for demodulation exists than information as with the parity bits which do not require the higher communication quality as with the systematic bits. This makes it possible to improve the communication quality in the multi-carrier communication system such as OFDM, or simplify the signal processing.

### BRIEF DESCRIPTION OF THE DRAWINGS

These and other objects and advantages of this invention will become more fully apparent from the following detailed description taken with the accompanying drawings in which:

FIG. 1 is a diagram showing an example of sub-carrier mapping according to a first embodiment of the present invention;

FIG. 2 is a diagram showing an example of a process of encoding a turbo code;

FIG. 3 is a diagram showing an example of a transmitter station according to the present invention;

FIG. 4 is a diagram showing an example of a receiver station according to the present invention;

FIG. 5 is a diagram showing an example of a channel encoder in the present invention when using a turbo code as a channel code;

FIG. 6 is a diagram showing an example of a channel encoder in the present invention when conducting repetition in a part of the channel code;

FIG. 7 is a diagram showing an example of a channel encoder in the present invention when using plural channel codes;

FIG. 8 is a diagram showing a transmitter station in an example of the present invention;

FIG. 9 is a diagram showing sub-carrier mapping in an example of the present invention;

FIG. 10 is a diagram showing a transmitter station in an example of the present invention;

FIG. 11 is a diagram showing signal mapping on time and frequency axes in an example of the present invention;

FIG. 12 is a diagram showing signal mapping on time and frequency axes in an example of the present invention; and

FIG. 13 is a diagram showing a procedure in a transmitter according to the present invention.

### DETAILED DESCRIPTION OF THE PREFERRED EMBODIMENTS

Now, a description will be given in more detail of preferred embodiments of the present invention with reference to the accompanying drawings.

In the following description, a signal mapping method according to the present invention is applied to a signal that is transmitted from a first radio station to a second radio station. The first radio station is called “transmitter station”, and the second radio station is called “second radio station”. On the other hand, the signal mapping method according to the present invention can be applied to both of the transmission of a signal from the first radio station to the second radio station and the transmission of a signal from the second radio station to the first station. In this case, the first and second radio stations conduct signal processing in both of the transmitter station and the receiver station, respectively.

For example, in a system such as a cellular system or a wireless LAN of an infrastructure mode where there exist a base station that is hereinafter called “fixed station” or an access point, and a user terminal that is hereafter called “mobile station”, when the present invention is applied to a communication from the fixed station to the mobile station, the fixed station corresponds to the transmitter station of the present invention, and the mobile station corresponds to the receiver station of the present invention. On the contrary, when the present invention is applied to a communication from the mobile station to the fixed station, the mobile station corresponds to the transmitter station of the present invention, and the fixed station corresponds to the receiver station of the present invention. Also, when the present invention is applied to both of the communications from the fixed station to the mobile station, and from the mobile station to the fixed station, the fixed station and the mobile station conduct both of the signal processing as the transmitter station and the receiver station, respectively.

Also, in a system such as a wireless LAN of an ad hoc mode where the terminals communicate directly with each other, when a signal to which the present invention is applied is transmitted, the respective terminals operate as the transmitter station of the present invention, respectively, and when a signal to which the present invention is applied is received, the respective terminals operate as the receiver station of the present invention, respectively.

Hereinafter, a description will be given of an OFDM system in which the respective sub-carriers are mapped to the frequencies which are orthogonal to each other by symbol unit as an embodiment of the present invention. However, the present invention is not limited to the OFDM system, but applicable to multi-carrier systems in which plural sub-carries are used, and parts of those sub-carriers are used as the criterion of demodulation.

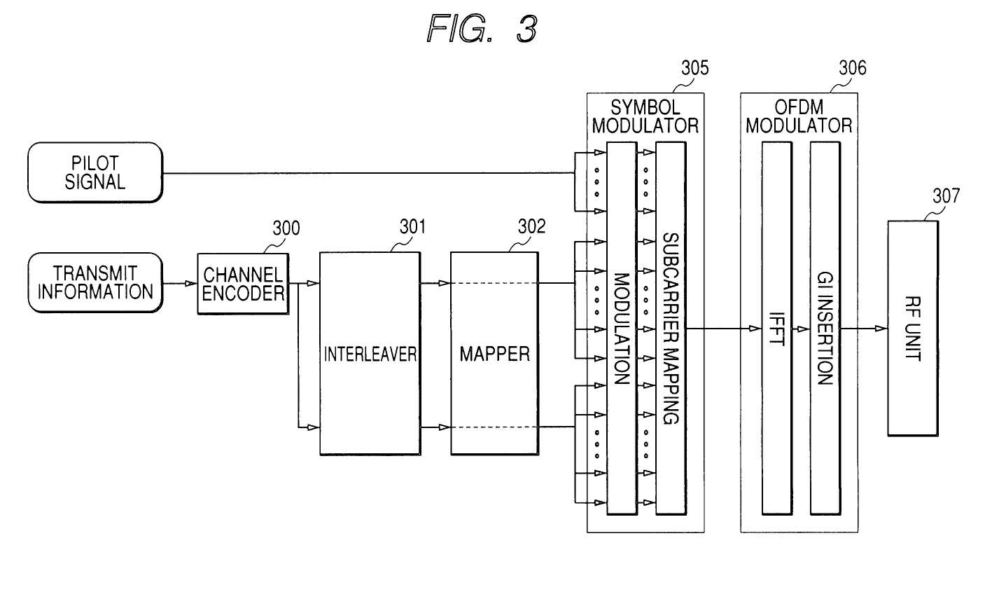

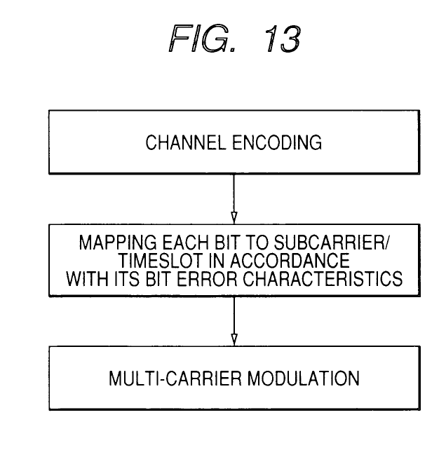

First, the outline of a procedure that is conducted at the transmitter side according to the present invention will be described with reference to FIG. 13. The transmit data is subjected to an encoding process to generate a code word. Then, bits of the code word are classified into bits important in accurately decoding the code work when decoding at the receiver side and bits not important, and those bits are mapped at frequencies and/or time slots which are close to the pilot signal in the important order. The transmit bits thus mapped are modulated in each of the sub-carriers and then transmitted. FIG. 3 is an example of the structure of the transmitter station and the flow of a signal according to the present invention.

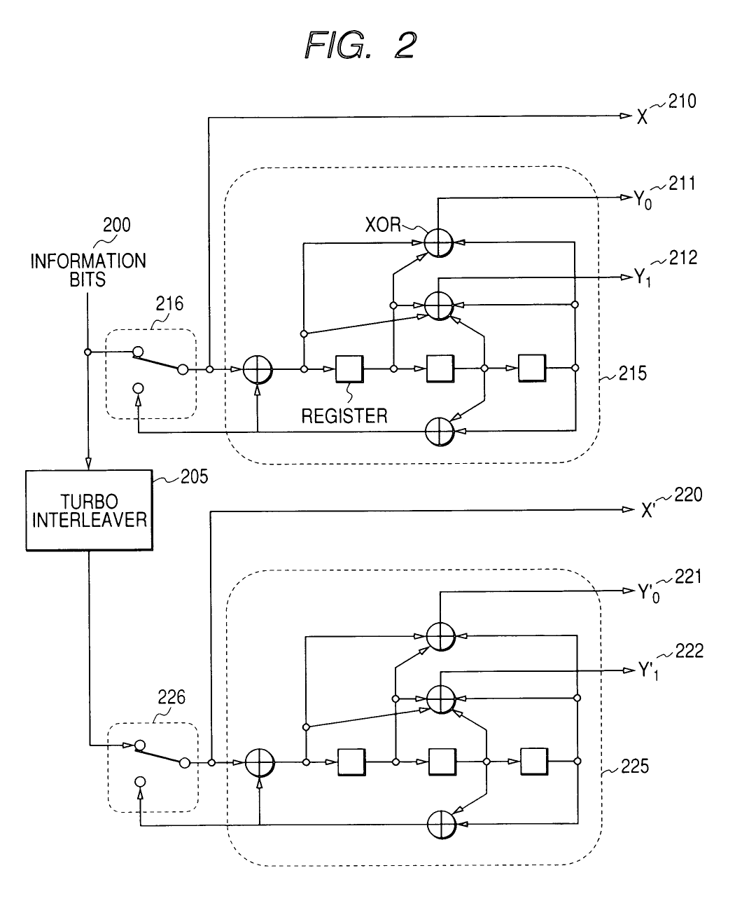

The transmit information is first encoded in the channel encoder 300, and separated into information that requires a high communication quality and other information. For example, in the case where the channel encoder 300 is the turbo encoder shown in FIG. 2, the information that requires the high communication quality is the systematic bits, and the other information is the parity bits. The channel encoded information is inputted to an interleaver 301, respectively. In the interleaver 301, the information that requires the high communication quality and the other information are interleaved, respectively, and then inputted to a mapper 302. In the mapper 302, the information that requires the high communication quality which has been interleaved, and the other information interleaved are so assigned as to correspond to the sub-carriers, respectively, and then inputted to a symbol modulator 305.

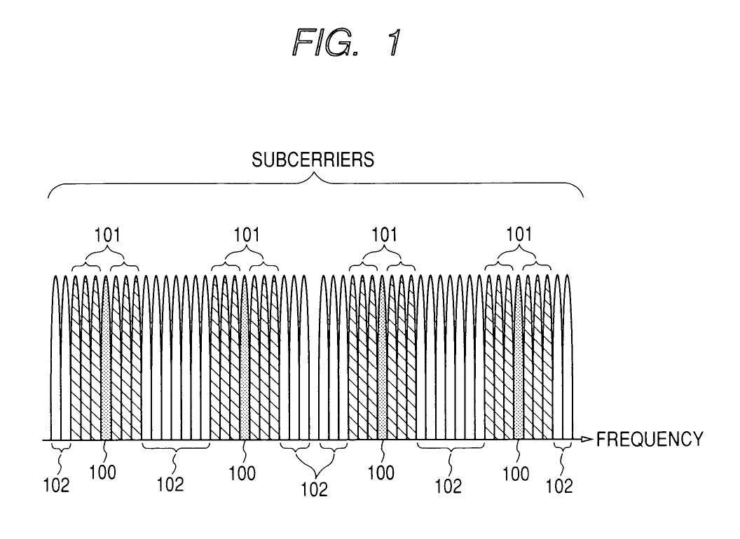

Information that is an output of the mapper 302 and a pilot signal that is a signal having a fixed phase and a fixed amplitude are inputted to the symbol modulator 305, and then modulated by using a modulation system such as PSK (phase shift keying) or QAM (quadrature amplitude modulation), respectively. The modulated signal is mapped to the subcarriers, mapped as in the signal mapping method of the subcarriers shown in FIG. 1, and then outputted from the symbol modulator 305.

FIG. 1 is a schematic diagram showing an example of a signal mapping method with respect to the subcarriers according to the present invention, and shows the appearance of the respective sub-carriers that are mapped on the frequency axis.

In FIG. 1, reference numeral 100 denotes subcarriers where the pilot signals that are hereinafter called “pilot carriers” are mapped, and reference numeral 101 and 102 denote subcarriers other than the pilot carriers. FIG. 1 shows an envelopment in which 52 subcarriers including 4 pilot carriers exist. However, the present invention is not limited to the number of those subcarriers, but the number of subcarriers and the number of pilot subcarriers are not limited.

In the subcarrier mapping process, the information that requires the high communication quality is mapped to the subcarriers 101 around (neighboring/adjacent to) the pilot subcarriers 100, and the other information is mapped to the subcarriers 102 not around (neighboring/adjacent to) the pilot subcarriers 100 by mapping the subcarriers.

FIG. 1 shows the appearance in which the number of subcarriers 101 around (neighboring/adjacent to) the pilot carriers 100 is the same as that of subcarriers 102 not around (neighboring/adjacent to) the pilot subcarriers 100. However, in the case where there is a difference between the information that requires the high communication quality and the other information, or in the case where the modulation system to be used is different depending on the subcarriers, that is, in the case where the number of subcarriers necessary to communicate the information that requires the high communication quality is different from the number of subcarriers necessary to communicate the other information, it is unnecessary that the number of subcarriers 101 around (neighboring/adjacent to) the pilot subcarriers 100 is identical with the number of subcarriers 102a not around (neighboring/adjacent to) the subcarriers 101.

A signal outputted from the symbol modulator 305 is inputted to an OFDM modulator (multi-carrier modulator) 306, and signals in the frequency ranges that are assigned to the respective subcarriers are converted into signals of time ranges. Each of the signals that have been into the time range is added with GI (guard interval) or CP (cyclic prefix), and transmitted from the radio frequency in an RF unit 307, to thereby conduct signal processing of the transmitter station to which the signal mapping method of the present invention is applied.

In the above description, the information that requires the high communication quality and the other information are separated from each other in the channel encoder 300, and processing conducted by the interleaver 301 and the subsequent elements are conducted in parallel. On the other hand, in the present invention, when the information that requires the high communication quality and the other information are identical with each other at the time of output from the symbol modulator 305 in the above description, those information may not be always separated at the time of output by the channel encoder 300.

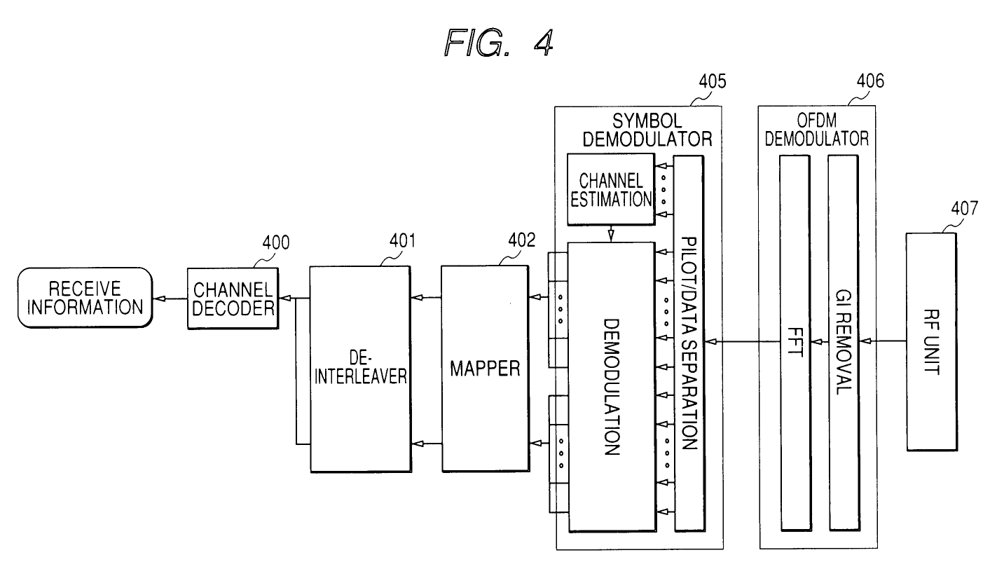

FIG. 4 is an example of the structure of the receiver station and the flow of a signal according to the present invention. In the receiver station of FIG. 4, a signal that has been received by an RF unit 407 is converted into a burst band signal and then inputted to an OFDM demodulator 406. In the OFDM demodulator 406, a symbol timing that conducts demodulation is determined taking a signal delay time in a channel into consideration to remove GI, and for example, an FFT (fast Fourier transform) process is applied to a receive signal for the symbol time after GI removal, to thereby convert the receive signal into a signal for each of the sub-carriers of the frequency range and output the converted signal to the symbol demodulator 405.

In the symbol demodulator 405, the pilot subcarriers and the data mapped subcarriers are separated from each other. The receive signal of the pilot subcarriers is first compared with the pilot signal having a fixed phase and a fixed amplitude, which is known as a signal transmitted in the transmitter station, as a channel estimation process, to thereby estimate variations in the phase and amplitude of the pilot subcarriers in the channel. In the channel estimation process, variations in the phase and amplitude of other subcarriers are further estimated from the variations in the phase and amplitude of the pilot subcarriers by an interpolation process. The signal of the data mapped subcarriers is demodulated on the basis of the channel estimation result, and then outputted from the symbol demodulator 405. As described above, the pilot signal is a reference signal used to estimate the variations in the phase and amplitude due to the channel propagation in the respective subcarriers.

The signal of the respective subcarriers which is outputted from the symbol demodulator 405 is subjected to inverse conversion of the conversion conducted by the mapper 302 in the transmitter station in the mapper 402, then subjected to inverse conversion of the interleave conducted by the interleaver 301 in the transmitter station in a deinterleaver 401, and then inputted to a channel demodulator 400. In the channel demodulator 400, the code used in the channel encoding process 300 in the transmitter station is demodulated, and a demodulation result is outputted as receive information. The mapping information is shared by the mapper 302 of the transmitter station and the mapper 402 of the receiver station in advance.

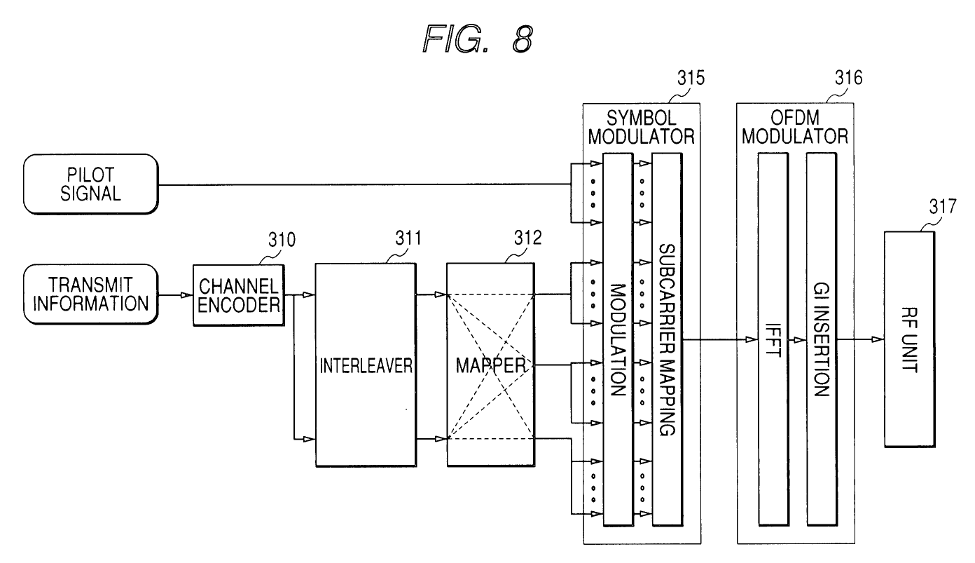

FIG. 8 is another example of a transmitter station in the present invention. In FIG. 8, the transmit information is first encoded in a channel encoder 310 and separated into the information that requires the high communication quality and the other information. The channel encoded information is inputted to an interleave 311, respectively. In the interleaver 311, the information that requires the high communication quality and the other information are subjected to an interleave process, and then inputted to a mapper 312. In the mapper 312, plural subcarrier groups that merge one or plural subcarriers are given, the information that requires the high communication quality and the other information, which have been interleaved are mixed together at the same or different rate in each of the groups and assigned, and outputted to a symbol modulator 315.

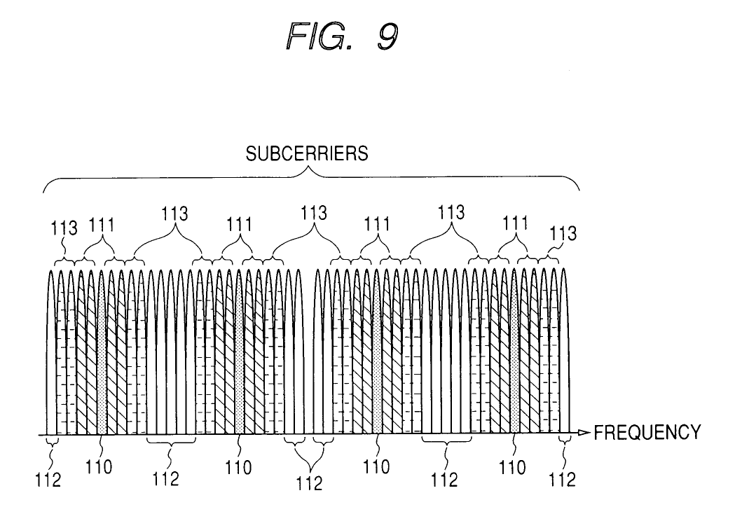

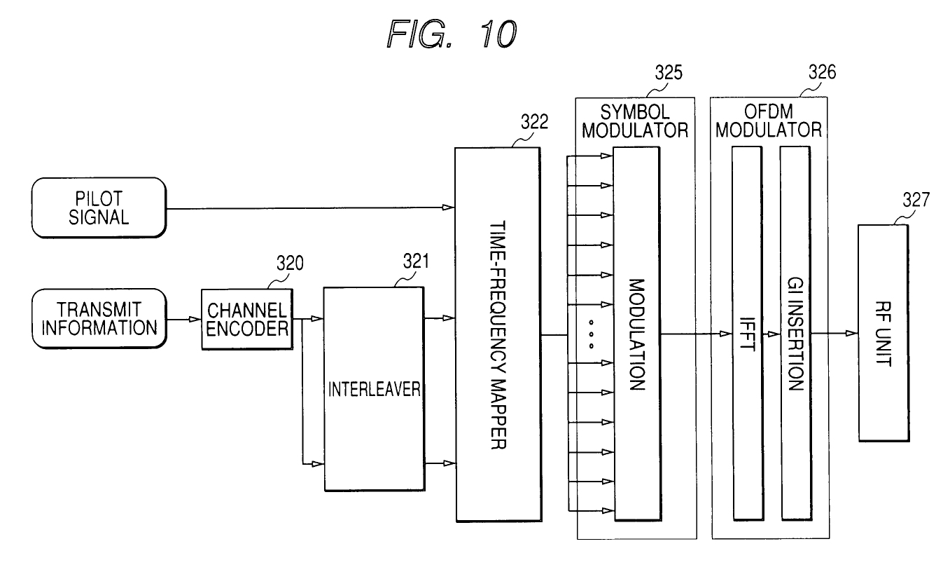

The symbol modulator 315 is inputted with the information that is an output of the mapper 312 and the pilot signal that is a signal having a fixed phase and a fixed amplitude, which are modulated through the modulation system such as PSK or QAM, respectively. The modulated signal is subjected to subcarrier mapping so as to be mapped as in the signal mapping method of the subcarriers shown in FIG. 9, and outputted from the symbol modulator 315.

FIG. 9 is a schematic diagram showing another example of the signal mapping method with respect to the subcarriers, and shows the appearance of the respective subcarriers mapped on the frequency axis.

In FIG. 9, reference numeral 110 denotes pilot carriers, reference numeral 111, 112, and 113 are subcarrier groups which are subcarriers having the frequencies closer to the pilot carriers in the stated order of the carrier groups 111, 112, and 113. FIG. 9 shows an envelopment in which there exist 52 subcarriers consisting of 4 pilot carriers and 48 subcarriers that are divided into 3 carrier groups. However, the present invention is not limited to the number of those subcarriers, and the number of subcarrier groups, the number of subcarriers, and the number of pilot subcarriers are not limited.

In the subcarrier mapping process, the subcarriers are mapped to the order from the subcarrier groups high in the rate at which the information that requires the high communication quality is included toward the subcarrier groups closer to the pilot subcarriers 110. In the example of FIG. 9, the rate of the information that requires the high communication quality with respect to the information included in the subcarrier group 111 is equal to or larger than the rate of the information that requires the high communication quality with respect to the information included in the subcarrier group 112. Likewise, the rate in the case of the subcarrier group 113 is smaller or equal to the rate in the case of the subcarrier group 112.

FIG. 9 shows the appearance in which the number of subcarriers that belong to the respective subcarrier groups 111, 112,and 113 are equal to each other. However, the number of subcarriers that belong to the respective subcarrier groups may be different from each other. Also, plural subcarrier groups are required, but not limited to three groups as shown in FIG. 9.

The signal outputted from the symbol modulator 315 is inputted to an OFDM modulator 316, and the signal of the frequency range which is assigned to each of the subcarriers by processing such as IFFT is converted into the signal of the time range. The signal that has been converted into the time range is added with GI, transmitted from the radio frequency in an RF unit 317, and subjected to signal processing in the transmitter station to which the signal mapping method of the present invention is applied.

The signal thus transmitted can be received through the same processing by the receiver station shown in FIG. 4.

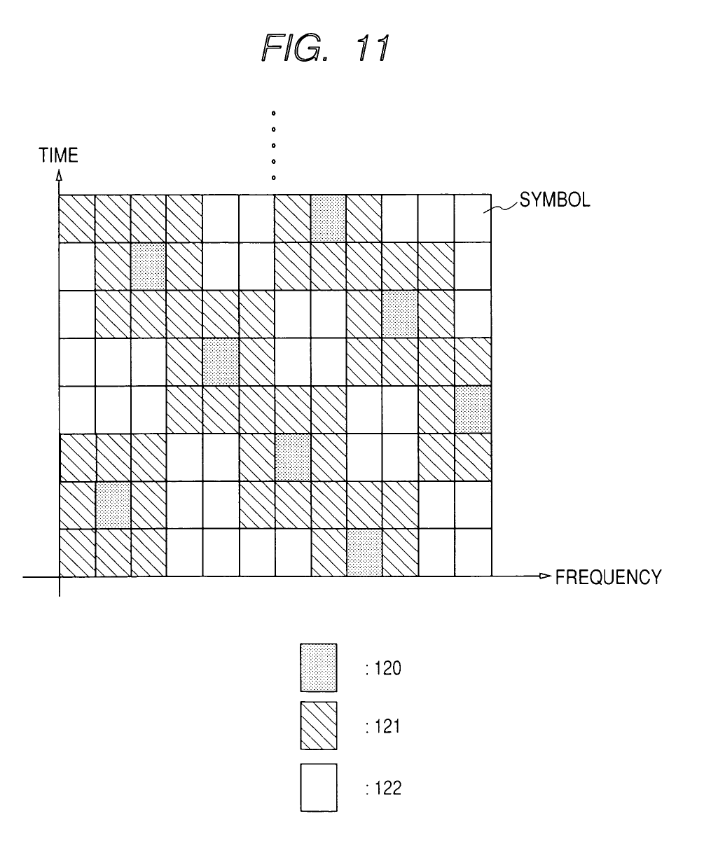

FIG. 10 shows still another example of the structure of the transmitter station and the flow of a signal in the present invention.

The transmit information is first encoded in the channel encoder 320 and divided into the information that requires the high communication quality and the other information. The channel encoded information is inputted to an interleaver 321. In the interleaver 321, the information that requires the high communication quality and the other information are subjected to the interleave process, respectively, and then inputted to a time-frequency mapper 322.

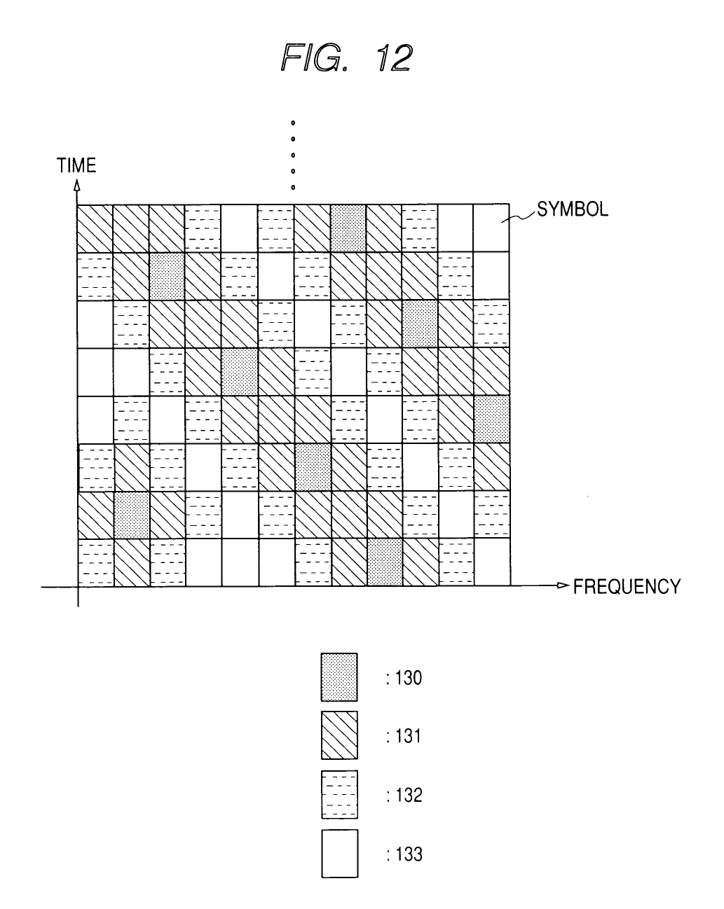

The time-frequency mapper 322 is inputted with an output of the interleaver 321 and a fixed-value signal for generating the pilot signal which is a signal having a fixed phase and a fixed amplitude. In the time-frequency mapper 322, the fixed value for generating the pilot signal, the information that requires the high communication quality which has been interleaved, and the other information are mapped as with symbol mapping shown in FIG. 11, and then outputted.

FIG. 11 is a schematic diagram showing the appearance of the symbol mapping of the time-frequency range in the time-frequency mapper in another example of the present invention. Reference numeral 120 denotes pilot symbols, reference numeral 121 is symbols of the time-frequency around (neighboring/adjacent to) the pilot symbol, and reference numeral 122 is symbols not around (neighboring/adjacent to) the pilot symbols. In this example, the information that requires the high communication quality is mapped to the symbols of the time and frequency around (neighboring/adjacent to) the pilot symbols 121, and the information that does not require the high communication quality is mapped to the symbols of the time and frequency not around (neighboring/adjacent to) the pilot symbols 122.

Also, FIG. 12 is a schematic diagram showing the appearance of the symbol mapping of the time-frequency range in the time-frequency mapper in still another example of the present invention. Reference numeral 130 denotes pilot symbols, reference numeral 131, 132, and 133 are symbol groups which indicate the symbols having the time and frequency closer to the pilot symbols in the stated order of 131, 132, and 133. In the time-frequency mapping process, the information that requires the high communication quality and the information that does not require the high communication quality are mixed together and then assigned to the respective symbol groups. In this situation, the information is assigned in the order from the symbol groups high in the rate at which the information that requires the high communication quality is included to the symbol groups closer to the pilot symbols. In the example of FIG. 12, the rate of the information that requires the high communication quality with respect to the information included in the subcarrier group 131 is equal to or larger than the rate of the information that requires the high communication quality with respect to the information included in the subcarrier group 132. Likewise, the rate in the case of the subcarrier group 133 is smaller or equal to the rate in the case of the subcarrier group 132.

A symbol modulator 325 is inputted with the information that is an output of the time-frequency mapper 322, which is modulated by using a modulation system such as PSK or QAM in each of the subcarriers, respectively. The signal that has been modulated in the symbol modulator 325 is inputted to an OFDM modulator 326, and the signal of the frequency range that is assigned to the respective subcarriers through processing such as IFFT is converted into a signal of the time range. The signal that has been converted into the time range is added with GI, transmitted from the radio frequency in an RF unit 307, and subjected to signal processing in the transmitter station to which the signal mapping method of the present invention is applied.

The signal thus transmitted can be received through the same processing by the receiver station shown in FIG. 4.

An example of the channel encoder will be described below. The following communication encoder is applicable to any one of the above-mentioned channel encoders 300, 310, and 320.

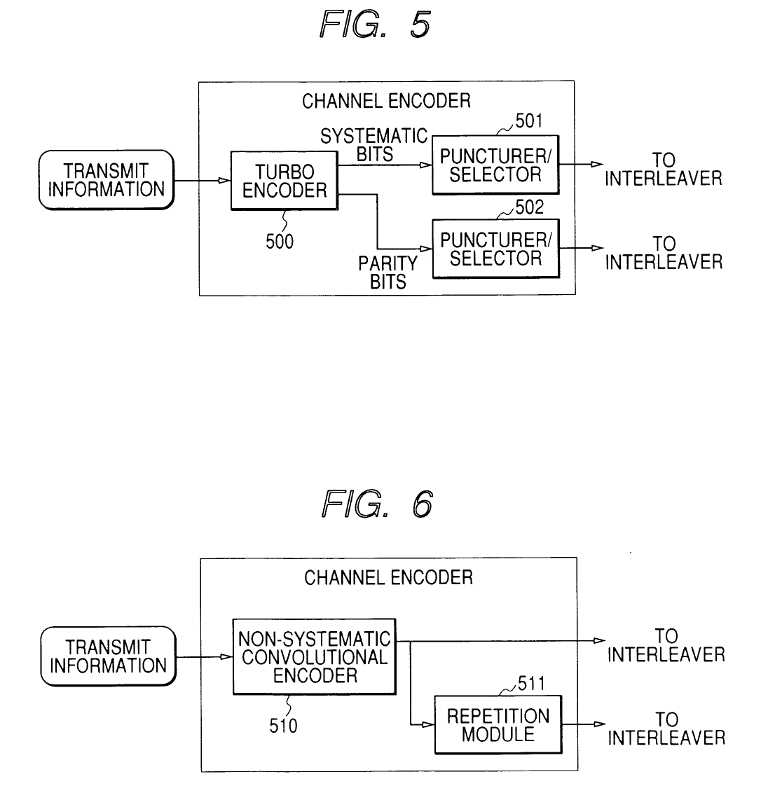

FIG. 5 shows an example of a communication encoder in using the turbo code. In the channel encoder, the transmit information is first encoded in, for example, a turbo encoder 500. The systematic bits in the turbo encoded code words are inputted to a selector/puncturer 501, and only the necessary bits are selected as the output of the channel encoder, and outputted to the interleaver as the information that requires the high communication quality.

On the other hand, the parity bits in the turbo encoded code words are inputted to a selector/puncturer 502, and only the necessary bits are selected as the output of the channel encoder, and then outputted to the interleaver as the information that does not require the high communication quality. The turbo code is used in this example. However, the present invention can use any code if the code can produce a difference in the error resistance of the bits within the code words generated by encoding, and in this case, the bits low in the error resistance is replaced with the systematic bits of the turbo codes in the above example, and the bits high in the error resistance is replaced with the parity bits of the turbo code in the above example. The bits high/low in the error resistance mean bits high/low in the possibility that the code words to which the bits belong are accurately demodulated even when the bits are erroneously received.

FIG. 6 shows an example of a channel encoder when subjecting a part of the channel code to repetition. In the channel encoder, the transmit information is first encoded in, for example, a non-systematic convolutional encoder 510. In this example, a non-systematic convolutional encoder is employed. However, any codes can be used in the present invention if the code is a channel code. For example, a turbo code, LDPC (low density parity check) code, a systematic convolutional code, or a Reed-Solomon code can be used. As an example, parts of the signals that have been subjected to the non-systematic convolutional encoding process are outputted as the information that requires the high communication quality directly to the interleaver. Also, the parts of the signals that have been subjected to the non-systematic convolutional encoding process are copied in a repetition module 511, and outputted to the interleaver as the information that does not require the high communication quality.

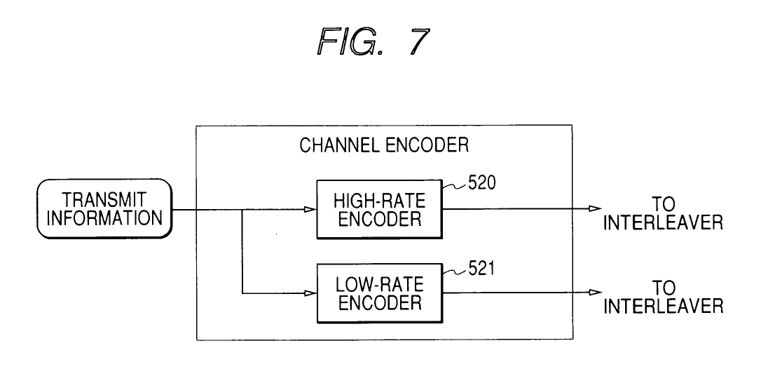

FIG. 7 shows an example of a channel encoder when using plural channel codes. In the channel encoder, the transmit information is inputted to a high-rate encoder 520 and a low-rate encoder 521. The signal that has been encoded in the high-rate encoder 520 is outputted to the interleaver as the information that requires the high communication quality, and the signal that has been encoded in the low-rate encoder 521 is outputted to the interleaver as the information that does not require the high communication quality. Any codes can be used for encoding in the high-rate encoder 520 and the low-rate encoder 521 if the codes are the channel codes. The high-rate encoder 520 conducts encoding by using the rate codes that are equal to or higher than those in the low-rate encoder 521.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An information transmitting method in a multi-carrier radio communication system in which a transmitter and a receiver communicate with each other by using a plurality of carriers, a pilot signal used as a reference signal of demodulation is transmitted by using a part of carriers, information different in required communication quality is combined together, and the combined information is divided into a plurality of carriers for communication,
wherein the transmitter maps information that requires a higher communication quality to carriers having a frequency closer to carriers by which the pilot signal is transmitted than information other than the information that requires the higher [symbol] [symbol] communication quality, and the respective mapped information is modulated in each of the carriers and transmitted.

2. The information transmitting method according to claim 1, wherein the information high in the required communication quality is systematic bits of code words of systematic codes, and the information low in the required communication quality is parity bits of the code words of the systematic codes.

3. The information transmitting method according to claim 2, wherein a turbo code is used as the channel code.

4. The information transmitting method according to claim 1, wherein the information high in the required communication quality is a part of the code words that are not subjected to repetition, and the information low in the required communication quality is a part of the code words that are subjected to repetition.

5. The information transmitting method according to claim 1, wherein the information low in the required communication quality is a part of the code words high in encoding rate as compared with the information high in the required communication quality.

6. A communication station in a multi-carrier radio communication system in which a transmitter and a receiver communicate with each other by using a plurality of carriers, a pilot signal used as a reference signal of demodulation is transmitted by using a part of carriers, the communication station comprising:
a channel encoder that encodes a transmit signal to output an encoded signal;
a multi-carrier modulator that modulates the pilot signal by any carrier; and
a mapper that divides information included in the code words into information that requires a higher communication quality and other information, and maps the information that requires a higher communication quality to carriers having a frequency closer to carriers by which the pilot signal is transmitted than the other information to output the information toward the multi-carrier modulator.

7. The communication station according to claim 6, wherein the information high in the required communication quality is systematic bits of code words of systematic codes, and the information low in the required communication quality is parity bits of the code words of the systematic codes.

8. The communication station according to claim 6 or 7, wherein the channel encoder uses a turbo code for encoding.

9. The communication station according to claim 6, wherein the information high in the required communication quality is a part of the code words that are not subjected to repetition, and the information low in the required communication quality is a part of the code words that are subjected to repetition.

10. The communication station according to claim 6, wherein the information low in the required communication quality is a part of the code words high in encoding rate as compared with the information high in the required communication quality.

11. The information transmitting method according to claim 1, wherein the carriers are grouped into a plurality of groups, and the signals are mapped in such a manner that a rate of the information that requires the higher communication quality is higher with the carrier groups having a frequency closer to the carriers by which the pilot signal is transmitted.

12. The communication station according to claim 6, wherein the carriers are grouped into a plurality of groups, and the mapper maps the signals in such a manner that a rate of the information that requires the higher communication quality is higher with the carrier groups having a frequency closer to the carriers by which the pilot signal is transmitted.

13. The information transmitting method according to claim 1,
wherein the pilot signals are discretely mapped in a part of carriers and time, and
wherein the information that requires the higher communication quality is mapped in a frequency and time closer to the carrier and the time in which the pilot signal is mapped than the information other than the information that requires the higher communication quality.

14. The communication station according to claim 6,
wherein the pilot signals are discretely mapped in a part of carriers and time, and
wherein the mapper maps the information that requires the higher communication quality in a frequency and time closer to the carrier and the time in which the pilot signal is mapped than the information other than the information that requires the higher communication quality.

15. The information transmitting method according to claim 1,
wherein the pilot signal is discretely mapped in a part of carriers and time, and
wherein the communication signal is grouped into a plurality of groups in each of the mapped time and frequencies, and the signals are mapped in such a manner that a rate of the information that requires the higher communication quality is higher with the groups having a time and frequency closer to the pilot signal.

16. The communication station according to claim 6,
wherein the pilot signal is discretely mapped in a part of carriers and time, and
wherein the communication signal is grouped into a plurality of groups in each of the mapped time and frequencies, and the mapper maps the signals in such a manner that a rate of the information that requires the higher communication quality is higher with the groups having a time and frequency closer to the pilot signal.
